(19) United States
(12) Patent Application Publication
(10) Pub. No.: US 2022/0105498 A1
(43) Pub. Date: Apr. 7, 2022

(54) RUTHENIUM-TRANSITION METAL ALLOY CATALYSTS

(71) Applicant: CORNELL UNIVERSITY, Ithaca, NY (US)

(72) Inventors: Hongsen WANG, Ithaca, NY (US); Héctor D. ABRUÑA, Ithaca, NY (US)

(73) Assignee: CORNELL UNIVERSITY, Ithaca, NY (US)

(21) Appl. No.: 17/430,613

(22) PCT Filed: Mar. 17, 2020
(86) PCT No.: PCT/US2020/023114

§ 371 Date: Aug. 12, 2021

Related U.S. Application Data
(60) Provisional application No. 62/820,029, filed on Mar. 18, 2019.

(51) Int. Cl. B01J 23/89; C25B 1/04; H01M 8/1004; H01M 4/90; C25B 13/00; C25B 9/19; B01J 21/18; C25B 11/065; C25B 11/089

(52) U.S. Cl. CPC B01J 23/8913; C25B 1/04; H01M 8/1004; H01M 4/9058; H01M 4/9083; C25B 9/19; B01J 21/18; C25B 11/065; C25B 11/089; C25B 13/00

(57) ABSTRACT

Provided is a catalytically active particle comprising an alloy, said alloy comprising: greater than or equal to 50 atomic % ruthenium (Ru); and 1 to 50 atomic % of one or more transition metals (M) selected from cobalt (Co), nickel (Ni), and iron (Fe), wherein the sum of the atomic percentages of Ru and M is greater than 65 atomic % of the alloy, and wherein, in the particle, the alloy is not fully or partially encapsulated by a layer of platinum atoms. Devices and processes employing the catalytically active particle are also provided.

### CROSS-REFERENCE TO RELATED APPLICATIONS

This application claims priority to U.S. Provisional Patent Application No. 62/820,029, filed Mar. 18, 2019, the disclosure of which is hereby incorporated by reference herein in its entirety.

### GOVERNMENT LICENSE RIGHTS

This invention was made with government support under DESC0019445 awarded by the Office of Science (DOE), and under DMR-1120296 awarded by the National Science Foundation. The United States Government has certain rights in the invention.

### FIELD OF THE INVENTION

This invention relates to, inter alia, a catalytically active particle comprising a ruthenium (Ru) transition metal (M) alloy, and to devices and processes employing the same.

### BACKGROUND

Alkaline-exchange membrane fuel cells (AEMFC's, also known as anion exchange membrane fuel cells), which operate in basic media, have the potential to exhibit higher efficiencies and better performance than proton exchange membrane fuel cells (PEMFC's), which operate in an acidic environment, in that the oxygen reduction reaction (ORR) kinetics can be significantly enhanced. However, while in acid media H₂ oxidation reaction (HOR) kinetics on platinum (Pt) are very facile, in alkaline media, the HOR kinetics on Pt are very sluggish, being over 100 times slower than in acidic media. Other Pt-group metals also exhibit a similar trend when going from acidic media to alkaline media. Thus, a need exists for improved materials to better enable AEMFC's as viable alternatives to other commercial fuel cells, such as PEMFC's.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, the present invention satisfies the need for improved materials to improve and better enable, inter alia, AEMFC's.

The invention provides, inter alia, catalytically active particles comprising a RuM (M=Co, Ni, Fe, or a combination thereof) alloy, said alloy comprising at least 50 atomic % Ru and 1 to 50 atomic % of M. The catalytically active particles find use as, e.g., catalysts for HOR and ORR (for example, in electrolyzers and fuel cells, such as AEMFC's).

Embodiments of the invention may address one or more of the problems and deficiencies discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Certain embodiments of the presently-disclosed catalytically active particles and related devices and processes/methods have several features, no single one of which is solely responsible for their desirable attributes. Without limiting the scope of the catalytically active particles and related compositions, devices and processes as defined by the claims that follow, their more prominent features will now be discussed briefly. After considering this discussion, and particularly after reading the section of this specification entitled “Detailed Description of the Invention,” one will understand how the features of the various embodiments disclosed herein provide a number of advantages over the current state of the art. These advantages may include, without limitation, providing alloys and compositions that have enhanced electrocatalytic activity toward HOR and/or ORR, providing alloys, compositions, and devices having improved HOR and/or ORR kinetics, providing low or lower cost catalysts (e.g., as compared to commercial catalysts such at Pt catalysts), providing improved fuel cells, e.g., providing improved anion-exchange membrane fuel cells, providing improved anode or cathode catalysts for fuel cell (e.g., AEMFC) applications, etc.

In a first aspect, the invention provides a catalytically active particle comprising an alloy, said alloy comprising:
greater than or equal to 50 atomic % ruthenium (Ru); and
1 to 50 atomic % of one or more transition metals (M) selected from cobalt (Co), nickel (Ni), and iron (Fe),
   wherein the sum of the atomic percentages of Ru and M is greater than 65 atomic % of the alloy, and wherein, in the particle, the alloy is not fully or partially encapsulated by a layer of platinum atoms.

In a second aspect, the invention provides a device comprising the catalytically active particle according to the first aspect of the invention.

In a third aspect, the invention provides an electrocatalytic process, wherein said process comprises use of the catalytically active particle according to the first aspect of the invention.

These and other objects, features, and advantages of this invention will become apparent from the following detailed description of the various aspects of the invention taken in conjunction with the accompanying drawings.

### BRIEF DESCRIPTION OF THE DRAWINGS

The present invention will hereinafter be described in conjunction with the following drawing figures. The depicted figures serve to illustrate various embodiments of the invention. However, the invention is not limited to the precise arrangements and instrumentalities of the embodiments in the drawings.

FIG. 1 depicts XRD patterns of embodiments of Ru₁₋ₓCoₓ/C catalysts with different Co contents. The reduction temperature was 300° C. for all catalysts, and the annealing temperature was 475° C. for Ru_{0.95}Co_{0.05/}C and Ru_{0.9}Co_{0.1}/C, and 425° C. for Ru_{0.7}Co_{0.3}/C and Ru_{0.5}Co_{0.5}/C.

FIGS. 2A-D are cyclic voltammograms depicting the effects of Co, Ni and Fe alloying with Ru on hydrogen adsorption/desorption kinetics. In particular, FIG. 2A depicts cyclic voltammograms of Ru_{0.95}Co_{0.05}/C, Ru_{0.95}Ni_{0.05}/C, Ru_{0.95}Fe_{0.05/}C and Ru/C in 0.1 M KOH. The catalyst loading was 14 μgₘₑₜₐₗ/cm². Scan rate was 50 mV/s. For all alloy catalysts, the reduction temperature was 300° C., and the annealing temperature was 475° C. FIG. 2B depicts cyclic voltammograms of Ru₁₋ₓCoₓ/C and Ru/C catalysts in 0.1 M KOH. The reduction temperature was 300° C., and the annealing temperature was 475° C. for Ru_{0.95}Co_{0.05}/C and Ru_{0.9}Co_{0.1}/C, and 425° C. for Ru_{0.7}Co_{0.3}/C and Ru_{0.5}Co_{0.5}/C. The catalyst loading was 14 μgₘₑₜₐₗ/cm². Scan rate was 50 mV/s. FIG. 2C depicts cyclic voltammograms of Ru₁₋ₓNiₓ/C and Ru/C catalysts in 0.1 M KOH. The reduction temperature was 300° C., and the annealing temperature was 475° C. for Ru_{0.95}Ni_{0.05}/C and Ru_{0.9}Ni_{0.1}/C, and 425° C. for Ru_{0.7}Ni_{0.3}/C. The catalyst loading was 14 μgₘₑₜₐₗ/cm². Scan rate was 50 mV/s. FIG. 2D depicts cyclic voltammograms of Ru₁₋ₓFeₓ/C and Ru/C catalysts in 0.1 M KOH. The reduction temperature was 300° C. for all catalysts, and the annealing temperature was 475° C. for Ru_{0.95}Fe_{0.05}/C and Ru_{0.9}Fe_{0.1}/C, and 425° C. for Ru_{0.7}Fe_{0.3}/C and Ru_{0.5}Fe_{0.5}/C. The catalyst loading was 14 μgₘₑₜₐₗ/cm². Scan rate was 50 mV/s.

FIGS. 3A-D are rotating disk electrode (RDE) voltammograms (A,C) and charts comparing HOR activity (B,D) for various Ru₁₋ₓMₓ/C catalyst embodiments. FIG. 3A depicts RDE voltammograms of Ru_{0.95}Fe_{0.05}/C, Ru_{0.95}Co_{0.05}/C, Ru_{0.95}Ni_{0.05}/C, Ru/C and Pt/C in H₂ saturated 0.1 M KOH. FIG. 3B is a chart comparing the HOR activity of Ru_{0.95}Fe_{0.05}/C, Ru_{0.95}Co_{0.05}/C, Ru_{0.95}Ni_{0.05}/C, Ru/C and Pt/C. FIG. 3C depicts RDE voltammograms of Ru₁₋ₓCoₓ/C catalysts in H₂ saturated 0.1 M KOH. FIG. 3D is a chart comparing the HOR activity of Ru₁₋ₓCoₓ/C catalysts. Scan rate: 5 mV/s. Rotation rate: 1600 rpm. The catalyst loading was 14 μgₘₑₜₐₗ/cm². MA: the mass activity at 0.01 V vs. RHE; SA: the specific activity at 0.01 V vs. RHE. The subscript “nm” indicates noble metals.

FIGS. 4A-B depict RDE voltammograms and a chart comparing HOR activity, respectively, for various Ru₁₋ₓMₓ/C catalyst embodiments. FIG. 4A depicts RDE voltammograms of Ru_{0.9}Fe_{0.1}/C, Ru_{0.9}Co_{0.1}/C, Ru_{0.9}Ni_{0.1}/C, Ru/C and Pt/C in H₂ saturated 0.1 M KOH. Scan rate: 5 m V/s. Rotation rate: 1600 rpm. The catalyst loading was 14 μgₘₑₜₐₗ/cm². The reduction temperature was 300° C. for all Ru alloy catalysts, and the annealing temperature was 475° C. FIG. 4B depicts a chart comparing the HOR activity of Ru_{0.9}Fe_{0.1}/C, Ru_{0.9}Co_{0.1}/C, Ru_{0.9}Ni_{0.1}/C, Ru/C and Pt/C. MA: the mass activity at 0.01 V vs. RHE; SA: the specific activity at 0.01 V vs. RHE; The subscript “nm” indicates noble metals.

FIGS. 5A-B depict RDE voltammograms and a chart comparing HOR activity, respectively, for various Ru₁₋ₓMₓ/C catalyst embodiments. FIG. 5A depicts RDE voltammograms of Ru₁₋ₓNiₓ/C catalysts in H₂ saturated 0.1 M KOH. Scan rate: 5 mV/s. Rotation rate: 1600 rpm. The catalyst loading was 14 μgₘₑₜₐₗ/cm². The reduction temperature was 300° C. for all catalysts, and the annealing temperature was 475° C. for Ru_{0.95}Ni_{0.05}/C and Ru_{0.9}Ni_{0.1}/C, and 425° C. for Ru_{0.7}Ni_{0.3}/C. FIG. 5B depicts a chart comparing the HOR activity of Ru₁₋ₓNiₓ/C catalysts. MA: the mass activity at 0.01 V vs. RHE; SA: the specific activity at 0.01 V vs. RHE.

FIGS. 6A-B depict RDE voltammograms and a chart comparing HOR activity, respectively, for various Ru₁₋ₓMₓ/C catalyst embodiments. FIG. 6A depicts RDE voltammograms of Ru₁₋ₓFeₓ/C catalysts in H₂ saturated 0.1 M KOH. Scan rate: 5 mV/s. Rotation rate: 1600 rpm. The catalyst loading was 14 μgₘₑₜₐₗ/cm². The reduction temperature was 300° C. for all catalysts, and the annealing temperature was 475° C. for Ru_{0.95}Fe_{0.05}/C and Ru_{0.9}Fe_{0.1}/C, and 425° C. for Ru_{0.7}Fe_{0.3}/C and Ru_{0.5}Fe_{0.5}/C. FIG. 6B depicts a chart comparing the HOR activity of Ru₁₋ₓFeₓ/C catalysts. MA: the mass activity at 0.01 V vs. RHE; SA: the specific activity at 0.01 V vs. RHE.

FIG. 7 depicts RDE voltammograms of Ru_{0.95}Co_{0.05}/C and Ru_{0.9}Co_{0.1}/C catalysts (annealed at 475° C.) in H₂ saturated 0.1 M KOH, compared to those of Ru_{0.9}Ir_{0.1}/C and Ru_{0.9}Pt_{0.1}/C. Scan rate: 5 mV/s. Rotation rate: 1600 rpm. The catalyst loading was 14 μgₘₑₜₐₗ/cm².

FIG. 8 depicts a chart comparing the hydrogen evolution reaction (HER) activity of Ru_{0.95}Fe_{0.05}/C, Ru_{0.95}Co_{0.05}/C, Ru_{0.95}Ni_{0.05}/C, Ru/C and Pt/C in H₂ saturated 0.1 M KOH. MA: the mass activity at −0.01 V vs. RHE; SA: the specific activity at −0.01 V vs. RHE; The subscript “nm” indicates noble metals.

FIGS. 9A-D are RDE voltammograms (A,C) and charts comparing ORR activity (B,D) for various Ru₁₋ₓMₓ/C catalyst embodiments. FIG. 9A depicts RDE voltammograms of Ru_{0.95}Fe_{0.05}/C, Ru_{0.95}Co_{0.05}/C, Ru_{0.95}Ni_{0.05}/C and Ru/C in O₂ saturated 0.1 M KOH. “(1)” and “(3)” indicate the first and the third positive-going scans, respectively. FIG. 9B is a chart comparing the ORR activity of Ru_{0.95}Fe_{0.05}/C, Ru_{0.95}Co_{0.05}/C, Ru_{0.95}Ni_{0.05}/C and Ru/C. For Ru_{0.95}Fe_{0.05}/C, the unpatterned and patterned bars denote the first and the third positive-going scans, respectively. FIG. 9C depicts RDE voltammograms of Ru₁₋ₓCoₓ/C catalysts in O₂ saturated 0.1 M KOH. FIG. 9D is a chart comparing the ORR activity of Ru₁₋ₓCoₓ/C catalysts. Scan rate: 5 mV/s. Rotation rate: 1600 rpm. The catalyst loading was 14 μgₘₑₜₐₗ/cm². MA: the mass activity at 0.85 V vs. RHE; SA: the specific activity at 0.85 V vs. RHE. The subscript “nm” indicates noble metals.

FIGS. 10A-B depict RDE voltammograms for oxygen evolution on Ru_{0.7}Fe_{0.3}/C, Ru_{0.7}Co_{0.3}/C, Ru_{0.7}Ni_{0.3}/C, and Ru/C in 0.1 M KOH (10A) and for oxygen evolution Ru₁₋ₓCoₓ/C, Ru/C and Ir/C catalysts in 0.1 M KOH (10B). Scan rate: 5 mV/s. Rotation rate: 400 rpm. The catalyst loading was 14 μgₘₑₜₐₗ/cm².

FIG. 11 depicts RDE voltammograms for oxygen evolution on Ru₁₋ₓNiₓ/C, Ru/C and Ir/C catalysts in 0.1 M KOH. Scan rate: 5 mV/s. Rotation rate: 400 rpm. The catalyst loading was 14 μgₘₑₜₐₗ/cm².

FIG. 12. depicts partial density of states of Ru d-band for Ru, Ru₇Pt₁, Ru₇Ir₁, and Ru₇Pd₁. Ru d-band centers are indicted in the figure.

FIG. 13 is a simplified schematic of an embodiment of an AEMFC, which is intended for ease of understanding, and is not intended to be drawn to scale or stoichiometrically accurate.

### DETAILED DESCRIPTION OF THE INVENTION

The present invention relates to, inter alia, a catalytically active particle comprising a ruthenium (Ru) transition metal (M) alloy, and to devices and processes employing the same.

Aspects of the present invention and certain features, advantages, and details thereof are explained more fully below with reference to the non-limiting embodiments discussed and illustrated in the accompanying drawings. Descriptions of well-known materials, fabrication tools, processing techniques, etc., are omitted so as to not unnecessarily obscure the invention in detail. It should be understood, however, that the detailed description and the specific examples, while indicating embodiments of the invention, are given by way of illustration only, and not by way of limitation. Various substitutions, modifications, additions and/or arrangements within the spirit and/or scope of the underlying inventive concepts will be apparent to those skilled in the art from this disclosure.

In a first aspect, the invention provides a catalytically active particle comprising an alloy, said alloy comprising:
greater than or equal to 50 atomic % ruthenium (Ru); and
1 to 50 atomic % of one or more transition metals (M) selected from cobalt (Co), nickel (Ni), and iron (Fe),
   wherein the sum of the atomic percentages of Ru and M is greater than 65 atomic % of the alloy, and wherein, in the particle, the alloy is not fully or partially encapsulated by a layer of platinum atoms.

As is known in the art, an alloy is a mixture of the elements comprised within it.

In some embodiments, the elements in the alloy of the catalytically active particle are homogeneously mixed.

In some embodiments, the alloy of the catalytically active particle is a single phase alloy.

Also as known in the art, atomic % (at. %) refers to the percentage of one or more atom(s) of an indicated kind relative to the total number of atoms present in an alloy.

As indicated above, embodiments of the catalytically active particle comprise a ruthenium-transition metal (Co, Ni, and/or Fe) alloy. The alloy may be referred to herein as the “alloy” or the “RuM alloy”.

In some embodiments, M is Co.

In some embodiments, M is Ni.

In some embodiments, M is Fe.

In some embodiments, the RuM alloy accounts for greater than or equal to 80 wt. % of the catalytically active particle. For example, in some embodiments, the RuM alloy accounts for greater than or equal to 81, 82, 83, 84, 85, 86, 87, 88, 89, 90, 91, 92, 93, 94, 95, 96, 97, 98, 99, 99.1, or 99.5 wt. % of the catalytically active particle. In some embodiments, the catalytically active particle consists of the alloy.

In the catalytically active particle, the alloy is not fully or partially encapsulated by a layer (i.e., one or more layers) of platinum atoms. Thus, the alloy is not coated with a layer of platinum atoms.

In some embodiments, the catalytically active particle does not comprise a coating on all or a portion of the alloy, other than an optional Ru coating (e.g., one or more atomic layers of Ru). In some embodiments, the catalytically active particle does not comprise a coating containing another platinum-group metal (besides Ru) on all or a portion of the alloy.

In some embodiments, the catalytically active particle is of substantially uniform (i.e., 90 - 100% uniform, e.g., at least 90, 91, 92, 93, 94, 95, 96, 97, 98, 99, or 99.5% uniform) composition.

In some embodiments, the catalytically active particle is in the form of a core-shell particle. In some embodiments, the core is the inventive alloy, and the shell is Ru. In some embodiments, the catalytically active particle is in the form of a core-shell particle, and the shell does not comprise Pt and/or Pd. In some embodiments, the catalytically active particle is not in the form of a core-shell particle.

In some embodiments, all or a portion of the exterior surface of the catalytically active particle is comprised of the RuM alloy. In some embodiments, at least 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% of the exterior surface area of the catalytically active particle is comprised of the RuM alloy.

The alloy comprises greater than or equal to 50 atomic % Ru (e.g., 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 at. %, including any and all ranges and subranges therein). In some embodiments, the alloy comprises greater than or equal to 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 atomic % Ru.

The alloy comprises 1 to 50 atomic % (e.g., 0.25, 0.50, 0.75, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 at%, including any and all ranges and subranges therein) of one or more transition metals (M) selected from cobalt (Co), nickel (Ni), and iron (Fe).

In some embodiments, the sum of the atomic percentages of Ru and M in the alloy is greater than or equal to 65 atomic % of the alloy (e.g., 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 at. %, including any and all ranges and subranges therein). For example, in some embodiments, the sum of the atomic percentages of Ru and M in the alloy is greater than or equal to 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.9 atomic % of the alloy.

In some embodiments, the alloy does not comprise greater than 5 atomic % (e.g., greater than 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 at. %) of rhodium, palladium, osmium, iridium, platinum, or any combination thereof. In some embodiments, the alloy does not comprise rhodium, palladium, osmium, iridium, and/or platinum.

In some embodiments, at least 90 volume % (e.g., at least 90, 91, 92, 93, 94, 95, 96, 97, 98, 99, or 99.5 vol%) of the alloy has a hexagonal close packed (hcp) crystal structure.

In some embodiments, the alloy is a binary alloy.

In some embodiments, the alloy is a ternary (or higher) alloy.

In some embodiments, the alloy is of formula (I):

Ru₁₀₀₋ₓMₓ (I),

wherein x is the atomic % of one or more transition metals (M) present, wherein M is selected from Co, Ni, Fe, and a combination thereof, and 1≤x≤50 (e.g., x is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, including any and all ranges and subranges therein). For example, in some embodiments, x is 4-50, 1-30, 3-40, etc.

In some embodiments, the alloy is of formula (I) and M is Co, Ni, or Fe.

In some embodiments, the catalytically active particle consists of:
greater than or equal to 50 atomic % Ru;
1 to 50 atomic % of one or more transition metals (M) selected from cobalt (Co), nickel (Ni), and iron (Fe); and
less than 5 atomic % of one or more additional elements.

In some embodiments, the catalytically active particle has a size of 1 to 50 nm (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 nm), including any and all ranges and subranges therein (e.g., 1.5 to 30 nm, 2 to 10 nm, etc.).

In some embodiments, the catalytically active particle is spherical in shape.

In some embodiments, the catalytically active particle is substantially spherical in shape. For example, in some embodiments, the catalytically active particle deviates from spherical by less than or equal to 10% (e.g., by less than or equal to 10, 9, 8, 7, 6, 5, 4, 3, 2, or 1%).

In some embodiments, the invention provides a plurality of catalytically active particles as described herein.

In some embodiments, the plurality of catalytically active particles have an average particle size of 1 to 50 nm (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 nm), including any and all ranges and subranges therein (e.g., 1.5 to 30 nm, 2 to 10 nm, etc.).

In some embodiments, the plurality of catalytically active particles, on average, deviate from spherical by less than or equal to 10% (e.g., by less than or equal to 10, 9, 8, 7, 6, 5, 4, 3, 2, or 1%).

In a second aspect, the invention provides a device comprising the catalytically active particle according to the first aspect of the invention.

In some embodiments, the device is a fuel cell.

The device can comprise any embodiment according to the first aspect of the invention, optionally in combination with properties of any other embodiment(s) according to the first aspect of the invention.

In some embodiments, the device comprises a plurality of catalytically active particles according to the first aspect of the invention.

In some embodiments, the device comprises two electrodes.

In some embodiments, the device is configured to transport hydroxide anions (OH⁻) from one electrode to the other.

In some embodiments, the device is a fuel cell.

In some embodiments, the device is a fuel cell, for example, an anion-exchange membrane fuel cell (AEMFC), comprising an anode and a cathode, wherein at least one of the anode or the cathode comprises the catalytically active particle according to the first aspect of the invention.

AEMFC's are alkaline fuel cells that comprise a solid polymer electrolyte, i.e., an alkaline exchange membrane. Currently, the most popular commercialized fuel cells are proton exchange membrane fuel cells (PEMFC's). PEMFC's and AEMFC's both generate electricity, but PEMFC's operate in acidic media, and comprise a proton-conducting polymer electrolyte membrane (PEM), whereas AEMFC's operate in alkaline media and comprise an anion exchange membrane (AEM) that conducts anions (such as OH⁻). In addition to the fact that the solid membrane in AEMFC's is an alkaline AEM instead of an acidic PEM, AEMFC's can be further distinguished from PEMFC's in that, for AEMFC's, the AEM transports ions (e.g., hydroxide ions, OH⁻) from the cathode to the anode, whereas proton (H⁺) conduction in a PEMFC goes from anode to cathode. The use of the AEM in the AEMFC creates an alkaline pH cell environment, thereby attractively opening up the possibilities for, inter alia, enhanced oxygen reduction catalysis (which could allow for the use of less expensive, e.g., platinum—(Pt) free catalysts, or catalysts that do not require Pt), extended range of fuel cell materials to be used (e.g., stable in the AEMFC, but that may not have sufficient stability in an acidic environment), and different range of possible membrane materials.

Depending on, e.g., the cathode oxidant gas, different anions are present in different amounts during the operation of an AEMFC. For example, when ambient air is used, anions present during operation of the AEMFC can include HCO₃⁻, CO₃²⁻, and OH⁻. Typically, though, when operated at high current densities, the most common anion species present across the AEM membrane is the hydroxide anion (OH⁻), initially present and also generated via electrochemical ORR at the cathode of the AEMFC.

During operation of an AEMFC, the OH⁻ is transported from the cathode to the anode. If hydrogen is used as fuel, the following oxidation reaction takes place at the anode:

2OH⁻+H₂→2H₂O+2e⁻

Thus, similar to PEMFC's, AEMFC's also produce water as a byproduct, but the water generated in an AEMFC is twice as much as in a PEMFC, per electron. Further, water is a reactant at the cathode.

The above discussion demonstrates various significant differences between AEMFC's and PEMFC's. Indeed, the alkaline environment and AEM, and different ORR and HOR mechanisms result in AEMFC's being significantly different from PEMFC's. Environmental and electrochemical differences between AEMFC's and PEMFC's are such that entirely different materials are used in the fuel cells, and materials useful for one type of fuel cell cannot be expected to be (and are often not) useful in the other. This point is exemplified, for example, by the fact that, while in acidic media H₂ oxidation kinetics on platinum (Pt) are very facile, in alkaline media, H₂ oxidation kinetics on Pt are very sluggish, being over 100 times slower than in acidic media. Thus, a need exists for improved materials that are specifically useful in alkaline conditions and for the development of improved AEMFC's. The Applicant has found that the catalytically active particle described herein offers such use, including, for example, as new anode and cathode catalysts for AEMFC's.

In some embodiments, the invention provides an AEMFC comprising:
an anode;
a cathode; and
an alkaline exchange membrane (AEM) configured to transport anions from the cathode to the anode,
   wherein the anode or the cathode comprises in contact therewith the catalytically active particle according to the first aspect of the invention.

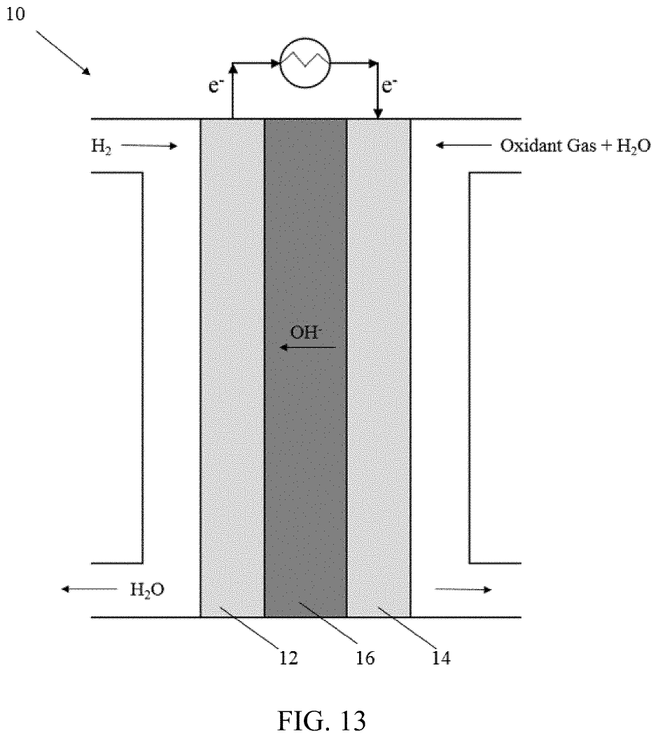

FIG. 13 is a simple schematic of an embodiment of an AEMFC 10. The schematic is for ease of reference and understanding; it is not necessarily drawn to scale, and, where reactants, anions, and products are shown, such illustration does not purport to convey accurate reaction stoichiometry. Referring to FIG. 13, AEMFC 10 comprises anode 12, cathode 14, and AEM 16.

In some embodiments, the anode comprises the inventive catalytically active particle, and the particle is supported on an electrically conductive carrier (e.g., the catalytically active particle is carbon-supported (e.g., carbon black supported)).

In some embodiments, the AEMFC anode does not comprise platinum and/or copper.

In some embodiments, the AEMFC does not comprise platinum and/or copper.

In some embodiments, the AEMFC is configured to use pure oxygen or air as a cathode oxidant gas. In some embodiments, the air is ambient air, CO₂-free air (also known as synthetic, or pure air), or CO₂-filtered air.

In some embodiments, the AEMFC is configured to use, as fuel, hydrogen or methanol. In particular embodiments, the AEMFC is configured to use hydrogen.

The AEM separates the anode and the cathode, and conducts OH⁻ions from the cathode to the anode. The AEM may be any anion exchange membrane configured for use in an AEMFC.

In some embodiments, the AEM is a polymeric anion exchange membrane comprising cationic moieties that are fixed to or within polymeric chains (vs., e.g., a liquid electrolyte, within which the cationic moieties would be freely mobile). In some embodiments, the AEM comprises a polymer backbone having cationic groups incorporated therein (e.g., alkylated poly(benzimidazoles)). In some embodiments, the AEM comprises a polymer backbone having cationic groups pendant/tethered thereto. For example, in some embodiments, the AEM comprises a hydroxide-conducting functionalized polysulfone (e.g., functionalized via chloromethylation, followed by reaction with a phosphine or quaternization with an amine to yield a phosphonium or ammonium salt that can be alkalinized, e.g., with KOH, to yield a hydroxide-conducting AEM). In some embodiments, the AEM comprises a quaternary ammonium polysulfone. In some embodiments, the AEM is based on a xylylene ionene.

In some embodiments, the inventive device is an alkaline electrolyzer.

In some embodiments, the alkaline electrolyzer comprises two electrodes configured to operate in a liquid alkaline electrolyte solution (e.g., of potassium hydroxide or sodium hydroxide). In some embodiments, the electrodes are separated by a diaphragm that separates product gases and transports hydroxide ions from one electrode to the other.

In some embodiments, the alkaline electrolyzer is a nickel-based electrolyzer.

In some embodiments, the alkaline electrolyzer is a water electrolyzer.

In some embodiments, the inventive catalytically active particle is comprised within an electrode of the electrolyzer. In some embodiments, the inventive alloy or electrocatalyst is comprised within the anode of the electrolyzer. In some embodiments, the inventive alloy or electrocatalyst is comprised within the cathode of the electrolyzer.

In a third aspect, the invention provides an electrocatalytic process, wherein said process comprises use of the catalytically active particle according to the first aspect of the invention.

In some embodiments the electrocatalytic process entails a method of electrocatalysis comprising use of the inventive catalytically active particle (e.g., as an anode or cathode catalyst).

The electrocatalytic process can comprise use of any embodiment according to the first aspect of the invention, optionally in combination with properties of any other embodiment(s) according to the first aspect of the invention.

Likewise, embodiments of the electrocatalytic process can comprise use or operation of a device according to the second aspect of the invention, optionally in combination with properties of any other embodiment(s) according to the first or second aspects of the invention.

In some embodiments, the electrocatalytic process comprises operating a device according to the third aspect of the invention.

In some embodiments, the electrocatalytic process is performed at a pH>7.

In some embodiments, the electrocatalytic process comprises transporting OH⁻ ions from a cathode to an anode, wherein the anode comprises the catalytically active particle according to the first aspect of the invention.

In some embodiments, the electrocatalytic process comprises an H₂ oxidation reaction (HOR). In some embodiments, the HOR takes place at the anode of a fuel cell, e.g., an AEMFC.

In some embodiments, the electrocatalytic process comprises both HOR and ORR.

In some embodiments, the electrocatalytic process does not comprise use of a platinum (Pt)-containing catalyst. In some embodiments, the electrocatalytic process does not comprise use of a platinum (Pt)-containing catalyst for the HOR reaction.

In some embodiments, the electrocatalytic process comprises a hydrogen evolution reaction. In some embodiments, the inventive catalytically active particle catalyzes the hydrogen evolution reaction. In some embodiments, the hydrogen evolution reaction is performed in alkaline media.

In some embodiments, the invention is as described in one or more of the following clauses.

Clause 1. A catalytically active particle comprising an alloy, said alloy comprising:
greater than or equal to 50 atomic % ruthenium (Ru); and
1 to 50 atomic % of one or more transition metals (M) selected from cobalt (Co), nickel (Ni), and iron (Fe),
   wherein the sum of the atomic percentages of Ru and M is greater than 65 atomic % of the alloy, and wherein, in the particle, the alloy is not fully or partially encapsulated by a layer of platinum atoms.

Clause 2. The catalytically active particle according to clause 1, wherein the sum of the atomic percentages of Ru and M is greater than or equal to 85 atomic % of the alloy.

Clause 3. The catalytically active particle according to clause 1 or clause 2, consisting of:
greater than or equal to 50 atomic % Ru;
1 to 50 atomic % of one or more transition metals (M) selected from cobalt (Co), nickel (Ni), and iron (Fe); and
less than 5 atomic % of one or more additional elements.

Clause 4. The catalytically active particle according to any one of clauses 1 to 3, wherein at least 90 volume % of the alloy has a hexagonal close packed (hcp) crystal structure.

Clause 5. The catalytically active particle according to any one of the preceding clauses, wherein the alloy is a single phase alloy.

Clause 6. The catalytically active particle according to any one of clauses 1, 2, 4, or 5, wherein the alloy is of formula (I):

Ru₁₀₀₋ₓMₓ (I),

wherein x is the atomic % of one or more transition metals (M) present, wherein M is selected from Co, Ni, Fe, and a combination thereof, and 1≤x≤50.

Clause 7. The catalytically active particle according to clause 6, wherein M is Co, Ni, or Fe.

Clause 8. The catalytically active particle according to any one of the preceding clauses, wherein M is Co.

Clause 9. The catalytically active particle according to any one of clauses 1 to 7, wherein M is Fe.

Clause 10. The catalytically active particle according to any one of clauses 1 to 7, wherein M is Ni.

Clause 11. The catalytically active particle according to clause 10, comprising 1 to 30 atomic % Ni.

Clause 12. The catalytically active particle according to any one of clauses 1 to 11, wherein at least 99 wt. % of the catalytically active particle consists of Ru and M.

Clause 13. The catalytically active particle according to any one of clauses 1 to 12, wherein the particle has a size of 1 to 50 nm.

Clause 14. A device comprising the catalytically active particle according to any one of clauses 1 to 13.

Clause 15. The device according to clause 14, wherein the device is an electrolyzer comprising an anode and a cathode, wherein said catalytically active particle is in direct electrical contact with at least one of the anode or the cathode.

Clause 16. A fuel cell comprising the catalytically active particle according to any one of clauses 1 to 13.

Clause 17. The fuel cell according to clause 16, wherein the fuel cell is an anion-exchange membrane fuel cell (AEMFC).

Clause 18. The AEMFC according to clause 17, comprising:
an anode;
a cathode; and
an anion-exchange membrane (AEM) configured to transport hydroxide ions from the cathode to the anode,
   wherein at least one of the anode or the cathode comprises the catalytically active particle according to any one of clauses 1 to 13.

Clause 19. An electrocatalytic process, wherein said process comprises use of the catalytically active particle according to any one of clauses 1 to 13.

Clause 20. The electrocatalytic process according to clause 19, wherein the process comprises a H₂ oxidation reaction (HOR), H₂ evolution reaction (HER), O₂ reduction reaction (ORR), or oxygen evolution reaction (OER).

Clause 21. The electrocatalytic process according to clause 19 or clause 20, wherein the process is performed at a pH >7.

Clause 22. The electrocatalytic process according to any one of clauses 19 to 21, wherein the process takes place in an anion-exchange membrane fuel cell (AEMFC).

Clause 23. The electrocatalytic process according to any one of clauses 19 to 21, wherein the process takes place in an anion-exchange membrane water electrolyzer (AEMWE).

### EXAMPLES

The invention will now be illustrated, but not limited, by reference to the specific embodiments described in the following examples.

Synthesis of Carbon Supported Nanoparticles. Electrocatalyst nanoparticles were prepared according to embodiments of the invention and comparative non-inventive embodiments. A series of Ru₁₋ₓCoₓ (11 wt. %), Ru₁₋ₓNiₓ (11 wt. %) and Ru₁₋ₓFeₓ (11 wt. %) nanoparticles supported on Vulcan XC-72R conductive carbon black with a metal loading of 11 wt. were synthesized by a wet impregnation method followed by subsequent forming gas reduction. This synthesis method yields surfactant-free carbon supported nanoparticles. The nanoparticles were well dispersed on the carbon support and exhibited mostly spherical shape. The reduction and annealing temperatures were selected to control the size of nanoparticle catalysts. Specified amounts of metal chlorides (RuCl₃, CoCl₂, NiCl₂ and FeCl₃) or metal nitrates (Ru(NO)(NO₃)₃, Co(NO₃)₂, Ni(NO₃)₂, and Fe(NO₃)₃) were dissolved in 10 mL of water, to which 40 mg of Vulcan XC-72R (oxidized at 400° C. for 12 hours to enhance hydrophilicity) were added. After 30 minutes of ultrasonication, the solution was heated and magnetically stirred on a heating plate to form a slurry. The slurry was then ultrasonicated for 10 minutes. Afterwards, the slurry was dried at 60° C. in air overnight. Finally, the dried powders were reduced at 300° C. for 2 hours in a flow furnace under a forming gas atmosphere (5% H₂, 95% Ar, Airgas, Ultrapure), and were then annealed under a forming gas atmosphere at different temperatures (shown in Table I) for 2 hours. The resulting nanoparticle size increased with increasing annealing temperatures. The flow furnace temperature was raised at a heating rate of 3 K/min. Ru/C (20 wt. %), Pt/C (20 wt. %) and Ru₉Pt₁/C (20 wt. %) and Ru₉Ir₁/C (20 wt. %) were also synthesized using the same procedure for comparison.

X-ray diffraction. The prepared catalysts were characterized by powder XRD in a Rigaku Ultima VI diffractometer with a Cu Ka source. Data were collected at a scan rate of 5°/min and with an increment of 0.02.

Energy dispersive X-ray absorption (EDX) spectroscopy. A LEO 1550 FESEM instrument, in which a field emission scanning electron microscopy (FESEM) is equipped with an energy dispersive X-ray spectrometer (EDX), was used to perform EDX spectroscopy.

Transmission Electron Microscopy (TEM). TEM was performed using a FEI Tecnai 12 BioTwin operated at 120 kV, which was equipped with a LaB₆ filament, and a high-resolution, high-contrast, thermoelectrically (TE) cooled Gatan Orius® 1000 dual-scan CCD camera. The fully motorized eucentric goniometer stage (CompuStage) could be tilted to ±80°.

Scanning Transmission Electron Microscopy (STEM) and EELS mapping. STEM images and electron energy loss spectroscopy (EELS) elemental maps were acquired using a fifth-order aberration-corrected FEI Titan Themis STEM operated at 300 keV with a sub-ångstrom spatial resolution. In order to detect the low Co content in Ru_{0.95}Co_{0.05}/C, the new K2 summit direct electron detector camera was employed to acquire EELS spectral images with a much higher signal-to-noise ratio and energy resolution than a regular CCD camera. EELS elemental mapping indicates that Ru and M are well distributed in nanoparticle embodiments, and no surface preferential distribution enrichment is observed.

Electrode preparation. First, Ru₁₋ₓCoₓ/C (11 wt. %), Ru₁₋ₓNiₓ/C (11 wt. %) and Ru₁₋ₓFeₓ/C (11 wt. %) catalyst inks were prepared by mixing 7.2 mg of catalyst powder, 0.8 mg of Vulcan XC-72R, 3.16 mL of Millipore water, 0.8 mL of isopropanol and 40 μL of Nafion solution (5 wt. %, Fuel Cell Store), and subsequent sonication for 15 minutes. Ru/C (20 wt. %) and Ru₉Pt₁/C (20 wt. %) and Ru₉Ir₁/C (20 wt. %) catalyst inks were prepared by mixing 4 mg of catalyst powder, 4 mg of Vulcan XC-72R, 3.16 mL of Millipore water, 0.8 mL of isopropanol and 40 μL of Nafion solution (5 wt. %, Fuel Cell Store), and subsequently sonicated for 15 minutes. A glassy carbon (GC) rotating disk electrode (RDE) with a diameter of 6 mm was polished with 1 μm diamond paste (Buehler), and then rinsed with acetone and Millipore water, respectively. Afterwards, 20 μL of catalyst ink were pipetted onto the GC electrode, and subsequently dried in air. An evenly dispersed thin film of catalyst was formed on the GC electrode with a catalyst loading of 14 μgₘₑₜₐₗ/cm².

Electrochemical tests. Electrochemical experiments were carried out with a WaveDriver 20 Bipotentiostat/Galvanostat, and AfterMath software (Pine Research Instrumentation). A three-electrode electrochemical cell made of Kel-F was used for alkaline media to avoid contamination from glass. An AFMSRCE Rotator (Pine Research Instrumentation) was used for H₂ oxidation/evolution, and oxygen reduction/evolution measurements. A Ag/AgCl (1M NaCl) electrode was used as the reference electrode, and all potentials are referred to a RHE (0.1 M KOH). The supporting electrolyte was prepared using Millipore water (18.2 MΩ·cm) and potassium hydroxide (99.99%, Sigma-Aldrich). Ar, H₂ and O₂ (high purity) were obtained from Airgas. For blank cyclic voltammogram measurements, all solutions were deaerated with high-purity Ar. All experiments were carried out at room temperature (20±1° C.).

Extraction of the mass activity, specific activity and the exchange current density. The kinetic currents for the HOR and ORR in alkaline media were calculated based on the Koutecky-Levich equation.

$${I}_{k} = I \cdot {I}_{D} \text{/} ( {I}_{D} - I )$$

where I is the measured current, and ID indicates the diffusion limited current.

The kinetic currents for the HOR, HER, ORR and OER in alkaline media were normalized to the mass of metals to obtain the mass activity.

$${I}_{k , m} = {I}_{k} \text{/} {M}_{m}$$

where Mₘ is the metal mass of the catalysts.

The electrochemical surface areas of the catalysts (Sₘ) were determined using the H adsorption charge. The kinetic currents for the HOR, HER, ORR and OER in alkaline media were normalized to the electrochemical surface area to obtain the specific activity.

$${I}_{k , s} = {I}_{k} \text{/} {S}_{m}$$

The Exchange current densities for the HOR/HER were obtained using the Butler-Volmer equation.

$${I}_{k , s} = {I}_{0} [ {e}^{( - α F \text{/} RT ) η} - {e}^{( ( 1 - α ) F \text{/} RT ) η} ]$$

$$log \frac{{I}_{k , s}}{1 - {e}^{( \frac{F}{RT} ) η}} = log {I}_{0} - \frac{α F η}{2.3 R}$$

$$log \frac{{I}_{k , s}}{1 - {e}^{( \frac{F}{RT} ) η}}$$

was plotted vs. η, then the exchange current density was obtained from the intercept.

DFT calculations. Calculations were performed using a periodic DFT with the generalized gradient approximation (GGA) of Perdew-Burke-Ernzerhof (PBE). Ultrasoft pseudopotentials and a plane-wave basis set with an energy cutoff of 30 Ry were used for all calculations. In order to improve convergence, a Methfessel-Paxton smearing function with a width of 0.02 Ry was used. The code used for the calculations was the Quantum-ESPRESSO 6.0 package. For lattice parameter calculations, an 8×8×8 Monkhorst-Pack k-point mesh sampling was used for Brillouin zone integration. The lattice constants of Ru (hcp) were calculated to be 2.7444, 2.7444 and 4.3446 Å, respectively, which are close to experimental values (2.7059, 2.7059 and 4.2815 Å).

A slab model was constructed from a 2×2 surface unit cell and consisted of four layers of metal atoms and a vacuum region of more than 10 Å. A 4×4×1 Monkhorst-Pack k-point mesh sampling was used for Brillouin zone integration. The metal atoms in the top two layers were allowed to relax, while the atoms in the bottom two layers were fixed to positions derived from DFT calculated lattice constants. To model Ru₃M₁ (M=Co, Ni, or Fe) alloys, one of the 4 Ru atoms in each layer was replaced by the second element M. To calculate the adsorption energy of H and O, a ¼ ML coverage was used. The adsorption energy of the adsorbates was obtained as E_{ads}=Eₜₒₜₐₗ−E_{slab}−E_{adsorbate}, in which Eₜₒₜₐₗ is the total energy of the slab with adsorbates, E_{slab} is the energy of the slab, and E_{adsorbate} is the energy of adsorbed species in the gas phase.

Synthesized nanoparticle catalysts and their properties are summarized in Table I.

TABLE I

| | | Reduction | Annealing | Particle | Lattice | | | | | |
|---|---|---|---|---|---|---|---|---|---|---|
| | | temperature | temperature | size | parameter | E_{1/2} | MA* | MA* | SA* | ECD* |
| Sample | Precursor | (° C.) | (° C.) | (nm) | (nm) | (V) | (A/m [symbol] ₘₑₜₐₗ) | (A/mg [symbol] ) | (mA/cm²) | (mA/cm [symbol] ²) |
| Pt/C | chloride | 150 | 225 | 3.4 | 0.3922 | 0.014 | 0.13 | 0.13 | 0.15 | 0 36 |
| Ru/C | chloride | 300 | | 3.4 | 0.2711 | 0.051 | 0.03 | 0.03 | 0.02 | 0.06 |
| | | | | | 0.4304 | | | | | |
| Ru_{0.95}Co_{0.05}/C | chloride | 300 | 475 | 3.3 | 0.2699 | 0.011 | 0.15 | 0.16 | 0.11 | 0.20 |
| | | | | | 0.4292 | | | | | |
| Ru_{0.9}Co_{0.} [symbol] /C | chloride | 300 | 450 | 2.3 | 0.2681 | 0.011 | 0.15 | 0.16 | 0.11 | 0.19 |
| | | | | | 0.4305 | | | | | |
| Ru_{0.9}Co_{0.} [symbol] /C | chloride | 300 | 475 | 3.1 | 0.2690 | 0.012 | 0.13 | 0.14 | 0.10 | 0.17 |
| | | | | | 0.4302 | | | | | |
| Ru_{0.9}Co_{0.} [symbol] /C | chloride | 300 | 500 | 3.3 | 0.2687 | 0.013 | 0.13 | 0.14 | 0.10 | 0.19 |
| | | | | | 0.4283 | | | | | |
| Ru_{0.9}Co_{0.} [symbol] /C | chloride | 300 | 700 | 8.6 | 0.2687 | 0.013 | 0.12 | 0.13 | 0.10 | 0.19 |
| | | | | | 0.4268 | | | | | |
| Ru_{0.7}Co_{0.} [symbol] /C | nitrate | 300 | 400 | 3.2 | 0.2663 | n.d. | | | | |
| | | | | | 0.4259 | | | | | |
| Ru_{0.7}Co_{0.} [symbol] /C | nitrate | 300 | 425 | 3.3 | 0.2664 | 0.016 | 0.10 | 0.12 | 0.11 | 0.24 |
| | | | | | 0.4250 | | | | | |
| Ru_{0.7}Co_{0.} [symbol] /C | nitrate | 300 | 500 | 10 | 0.2663 | n.d. | | | | |
| | | | | | 0.4236 | | | | | |
| Ru_{0.7}Co_{0.} [symbol] /C | nitrate | 300 | 700 | 19 | 0.2659 | n.d. | | | | |
| | | | | | 0.4221 | | | | | |
| Ru_{0.5}Co_{0.5}/C | nitrate | 300 | 400 | 3.0 | 0.2621 | n.d. | | | | |
| | | | | | 0.4250 | | | | | |
| Ru_{0.5}Co_{0.5}/C | nitrate | 300 | 425 | 3.3 | 0.2630 | 0.021 | 0.07 | 0.11 | 0.12 | 0.30 |
| | | | | | 0.4212 | | | | | |
| Ru_{0.95}Ni [symbol] _{.05}/C | chloride | 300 | 425 | 2.9 | 0.2696 | n.d. | | | | |
| | | | | | 0.4310 | | | | | |
| Ru_{0.9}Ni_{0.05}/C | chloride | 300 | 450 | 3.0 | 0.2701 | 0.012 | 0.14 | 0.14 | 0.10 | 0.18 |
| | | | | | 0.4295 | | | | | |
| Ru_{0.9}Ni_{0.5}/C | chloride | 300 | 475 | 3.6 | 0.2696 | 0.012 | 0.14 | 0.14 | 0.09 | 0.18 |
| | | | | | 0.4290 | | | | | |
| Ru_{0.9}Ni [symbol] /C | chloride | 300 | 450 | 2.8 | 0.2690 | 0.013 | 0.12 | 0.13 | 0.09 | 0.17 |
| | | | | | 0.4293 | | | | | |
| Ru_{0.9}Ni [symbol] /C | chloride | 300 | 475 | 3.1 | 0.2688 | 0.015 | 0.10 | 0.11 | 0.07 | 0.16 |
| | | | | | 0.4292 | | | | | |
| Ru_{0.9}Ni [symbol] /C | chloride | 300 | 500 | 4.3 | 0.2690 | 0.013 | 0.11 | 0.12 | 0.09 | 0.17 |
| | | | | | 0.4272 | | | | | |
| Ru_{0.7}Ni [symbol] /C | nitrate | 300 | 425 | 3.4 | 0.2656 | 0.015 | 0.11 | 0.14 | 0.13 | 0.24 |
| | | | | | 0.4336 | | | | | |
| Ru_{0.95}Fe_{0.05}/C | chloride | 300 | 425 | 2.5 | 0.2702 | n.d. | | | | |
| | | | | | 0.4308 | | | | | |
| Ru_{0.95}Fe_{0.05}/C | chloride | 300 | 450 | 2.7 | 0.2698 | n.d. | | | | |
| | | | | | 0.4323 | | | | | |
| Ru_{0.95}Fe_{0.05}/C | chloride | 300 | 475 | 3.3 | 0.2705 | 0.012 | 0.15 | 0.16 | 0.107 | 0.19 |
| | | | | | 0.4277 | | | | | |
| Ru_{0.9}Fe [symbol] /C | chloride | 300 | 450 | 3.3 | 0.2700 | n.d. | | | | |
| | | | | | 0.4294 | | | | | |
| Ru_{0.9}Fe [symbol] /C | chloride | 300 | 475 | 3.5 | 0.2697 | 0.013 | 0.13 | 0.14 | 0.09 | 0.18 |
| | | | | | 0.4291 | | | | | |
| Ru_{0.9}Fe [symbol] /C | chloride | 300 | 500 | 4.3 | 0.2697 | n.d. | | | | |
| | | | | | 0.4291 | | | | | |
| Ru [symbol] Fe_{0.3}/C | nitrate | 300 | 425 | 3.3 | 0.2660 | 0.016 | 0.10 | 0.13 | 0.12 | 0.23 |
| | | | | | 0.4285 | | | | | |
| Ru_{0.5}Fe_{0.3}/C | nitrate | 300 | 450 | 3.4 | 0.2613 | 0.018 | 0.09 | 0.14 | 0.11 | 0.21 |
| | | | | | 0.4288 | | | | | |
| Ru_{0.9}Pt_{0.} [symbol] /C | chloride | 300 | | 3.6 | 0.2715 | 0.012 | 0.14 | 0.14 | 0.11 | 0.20 |
| | | | | | 0.4288 | | | | | |
| Ru_{0.9} [symbol] /C | chloride | 325 | | 2.7 | 0.2706 | 0.013 | 0.12 | 0.12 | 0.08 | 0.16 |
| | | | | | 0.4285 | | | | | |

[symbol]

indicates data missing or illegible when filed

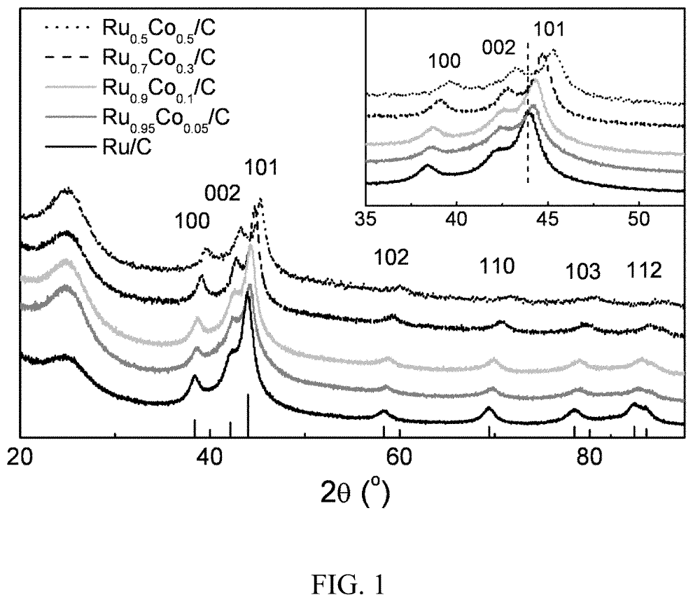

FIG. 1 depicts X-ray diffraction patterns of embodiments of the Ru₁₋ₓCoₓ/C catalysts with different Co contents. The reduction temperature was 300° C. for all catalysts, and the annealing temperature was 475° C. for Ru_{0.95}Co_{0.05}/C and Ru_{0.9}Co_{0.1}/C, and 425° C. for Ru_{0.7}Co_{0.3}/C and Ru_{0.5}Co_{0.5}/C. The broad peak at ca. 25° is ascribed to the carbon support. All studied Ru₁₋ₓCoₓ/C catalysts exhibited the same hexagonal close packed structure as Ru/C, indicated by the fact that the diffraction peaks of all samples matched the standard Ru diffraction peaks. As the Co content increased, the diffraction peaks of Ru₁₋ₓCoₓ/C (0≤x≤0.5) shifted towards higher angles (FIG. 1), suggesting that the Co atoms are incorporated into the Ru lattice. This is consistent with the fact that Co atoms are about 8% smaller than Ru atoms. As annealing temperature increased, the XRD peaks became narrower, indicating that the mean size of the nanoparticles increased. X-ray diffraction patterns for Ru₁₋ₓNiₓ/C (0.05≤x≤0.5) and Ru₁₋ₓFeₓ/C (0.05≤x≤0.5) nanoparticles (not shown) were quite similar to Ru₁₋ₓCoₓ/C (0≤x≤0.5).

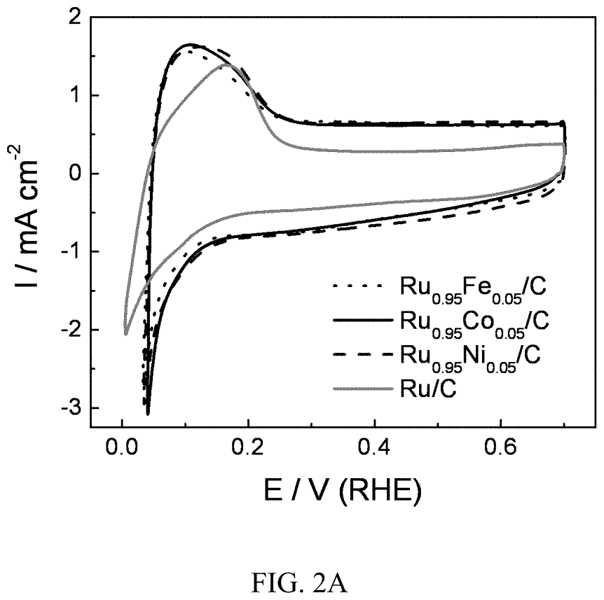

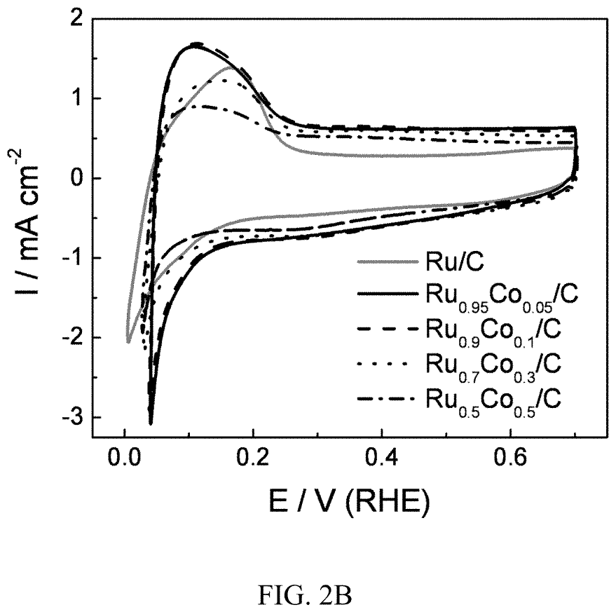

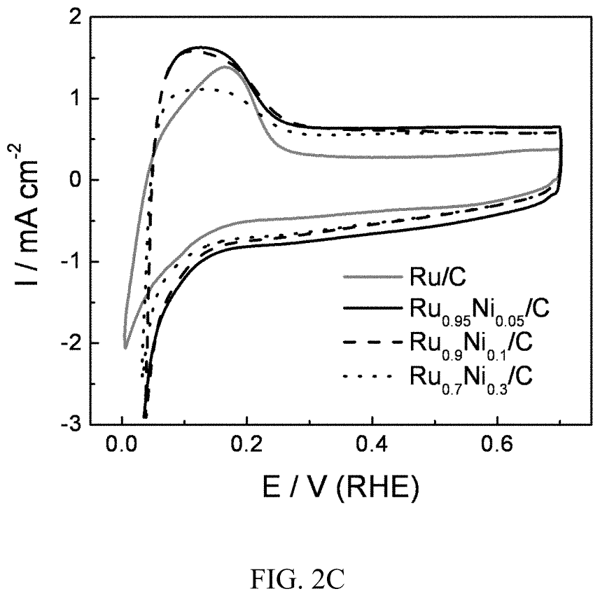

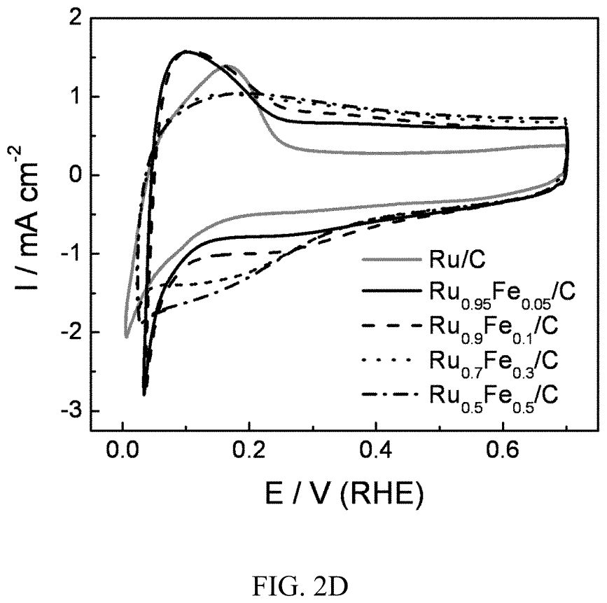

Hydrogen Oxidation Reaction. The effects of Co, Ni and Fe alloying with Ru on the hydrogen adsorption/desorption kinetics are shown in FIGS. 2A-D. H adsorption/desorption processes on Ru/C are very sluggish, as indicated by the irreversible peaks. After alloying with only 5 at. % of Co, Ni or Fe, the H adsorption/desorption kinetics on Ru/C are significantly enhanced, as indicated by the increase in the reversibility of H adsorption/desorption peaks. With an increase in the contents of Co, Ni or Fe, the H desorption charge decreased, suggesting that H only adsorbs on Ru sites rather than on Co, Ni or Fe sites, likely due to the blocking effect of the oxide/hydroxide layer formed on Co, Ni or Fe sites. Due to the reversibility of H adsorption/desorption processes, the HOR activity, as well as HER activity, of Ru₁₋ₓCoₓ/C, Ru₁₋ₓNiₓ/C and Ru₁₋ₓFeₓ/C catalysts increased significantly.

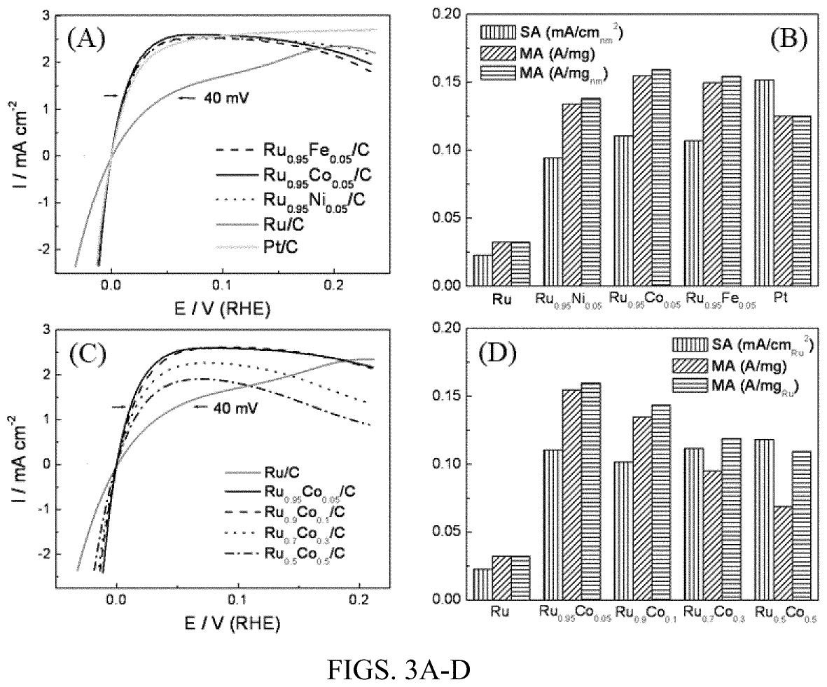

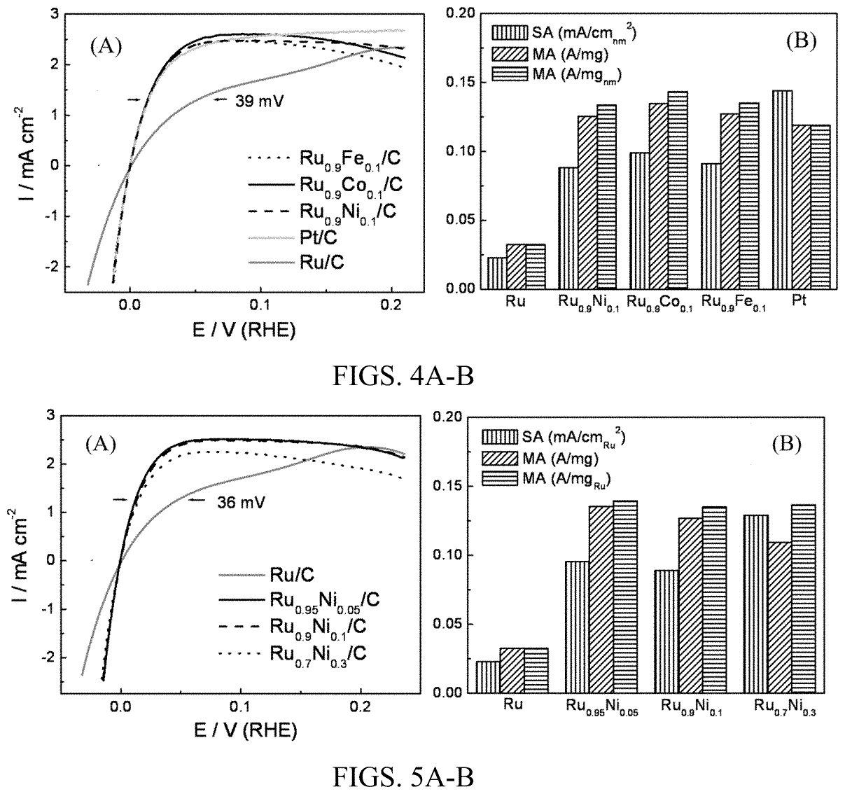

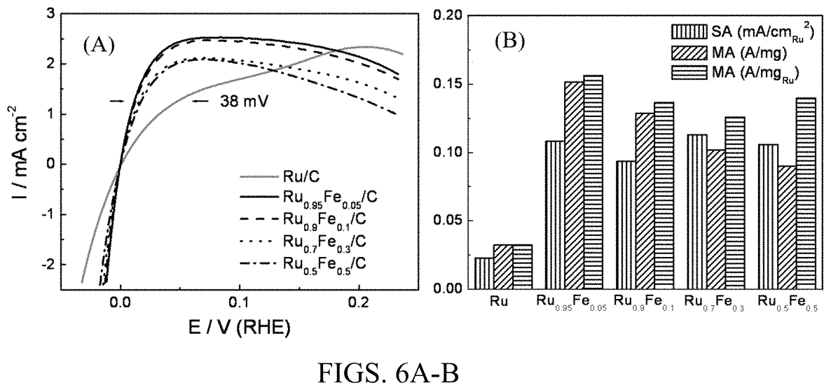

FIG. 3A compares the rotating disk electrode (RDE) voltammograms for the HOR and HER of Ru_{0.95}Co_{0.05}/C, Ru_{0.95}Ni_{0.05}/C, Ru_{0.95}Fe_{0.05}/C with Ru/C and Pt/C in H₂-saturated 0.1 M KOH solution. All studied Ru_{0.95}Mo_{0.5}/C (M=Fe, Co, or Ni) catalysts were much more active than Ru/C, and even more active than Pt/C. Ru_{0.95}Co_{0.05}/C was superior to Ru_{0.95}Fe_{0.05}/C and Ru_{0.95}Ni_{0.05}/C. The half-wave potential for the HOR on Ru_{0.95}Co_{0.05}/C was negatively shifted by about 40 mV, when compared to Ru/C. The specific activity (SA) and mass activity (MA) at an overpotential of +10 mV for the HOR on Ru_{0.95}Co_{0.05}/C, Ru_{0.95}Ni_{0.05}/C, Ru_{0.95}Fe_{0.05}/C, Ru/C and Pt/C are compared in FIG. 3B. As for the MA, Ru_{0.95}Co_{0.05}/C was the most active catalyst for the HOR among all studied catalysts, and was about 5 times more active than pure Ru/C, and 20% more active than Pt/C. Regarding the SA, Ru_{0.95}Co_{0.05}/C was also 5 times more active than pure Ru/C, and was comparable to Pt/C. The HOR activity of Ru_{0.9}Co_{0.1}/C, Ru_{0.9}Ni_{0.1}/C, Ru_{0.9}Fe_{0.1}/C, Ru/C and Pt/C are also compared in FIGS. 4A-B. All studied Ru_{0.9}Mo_{0.1}/C (M=Fe, Co, or Ni) catalysts were also much more active than Ru/C, and even more active than Pt/C. Ru_{0.9}Co_{0.1}/C exhibited a slightly higher activity than Ru_{0.9}Fe_{0.1}/C and Ru_{0.9}Ni_{0.1}/C. The effect of Co content on the HOR activity of Ru₁₋ₓCoₓ/C catalysts is presented in FIGS. 3C-D. Among all studied Ru₁₋ₓCoₓ/C catalysts, as for the MA, Ru_{0.95}Co_{0.05}/C was the most active. Even after normalizing the current to the mass of Ru, Ru_{0.95}Co_{0.05}/C is still the most active catalyst. However, if one normalizes the current to the Ru surface area, determined from the H adsorption charge, the HOR activities for all studied Ru₁₋ₓCoₓ/C catalysts are comparable. This suggests that the Ru surface sites of Ru₁₋ₓCoₓ/C catalysts might be the reactive sites for the HOR, while the Co atoms provide electronic effects, which weaken the H binding energy to Ru sites. Similarly, Ru_{0.95}Ni_{0.05}/C and Ru_{0.95}Fe_{0.05}/C were also the most active catalysts among all studied Ru₁₋ₓNiₓ/C and Ru₁₋ₓFeₓ/C catalysts, respectively, in term of the MA (FIGS. 5A-B and FIGS. 6A-B). The HOR activities, normalized to the Ru surface area, for all studied Ru₁₋ₓNiₓ/C or Ru₁₋ₓFeₓ/C catalysts are comparable, similar to the case of Ru₁₋ₓCoₓ/C.

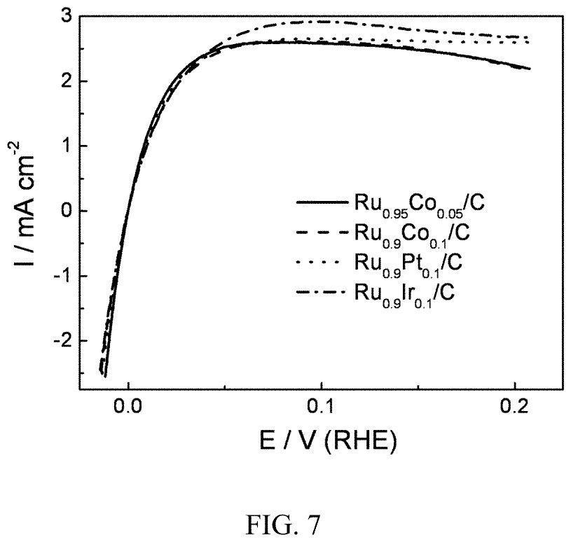

PtRu/C and IrRu/C are among the best binary catalysts for the HOR, and the HOR activity of Ru_{0.95}Co_{0.05}/C and Ru_{0.9}Co_{0.1}/C are compared to that of Ru_{0.9}Pt_{0.1}/C and Ru_{0.9}Ir_{0.1}/C in FIG. 7. The HOR activities of Ru_{0.95}Co_{0.05}/C and Ru_{0.9}Co_{0.1}/C are comparable to, or even superior to those of Ru_{0.9}Pt_{0.1}/C and Ru_{0.9}Ir_{0.1}/C.

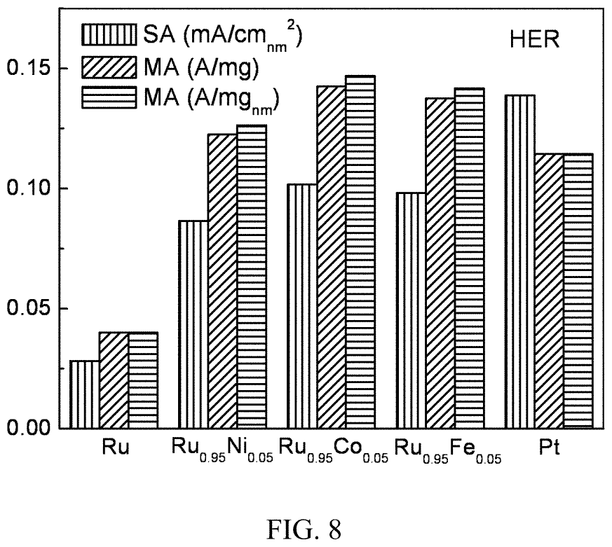

Hydrogen Evolution Reaction. Similar to the HOR, the HER activity was also enhanced for all the studied Ru₁₋ₓMₓ/C (M=Co, Ni, Fe, 0<x≤0.5) catalysts, when compared to pure Ru/C (FIGS. 3A-D, 4A-B, 5A-B, and 6A-B). Ru_{0.95}Co_{0.05}/C, Ru_{0.95}Fe_{0.05}/C and Ru_{0.95}Ni_{0.05}/C were the most active catalysts, for the HER, among all the studied Ru₁₋ₓCoₓ/C, Ru₁₋ₓFeₓ/C and Ru₁₋ₓNiₓ/C catalysts. The SA and MA for the HER on Ru_{0.95}Co_{0.05}/C, Ru_{0.95}Fe_{0.05}/C and Ru_{0.95}Ni_{0.05}/C, Ru/C and Pt/C at an overpotential of −10 mV are compared in FIG. 8. In terms of the MA, the activities of Ru_{0.95}Co_{0.05}/C, Ru_{0.95}Fe_{0.05}/C and Ru_{0.95}Ni_{0.05}/C are about 4 times higher than that of pure Ru/C, and even superior to Pt/C. Ru_{0.95}Co_{0.05}/C was the most active catalyst for the HER in terms of the MA and SA, and was even more active than Ru_{0.9}Pt_{0.1}/C and Ru_{0.9}Ir_{0.1}/C (FIG. 7).

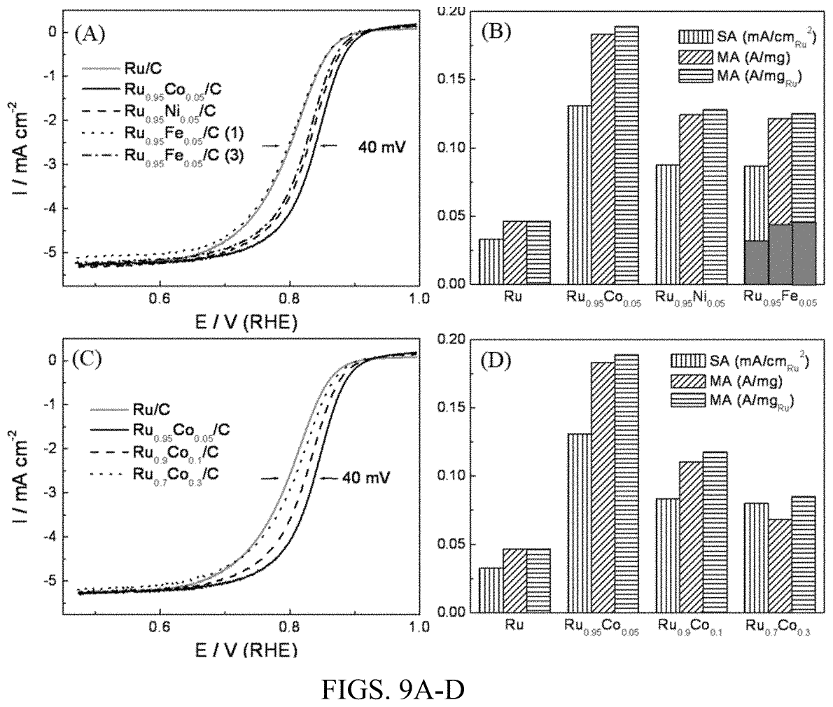

Oxygen Reduction Reaction. FIG. 9A presents the RDE voltammograms of Ru_{0.95}Co_{0.05}/C, Ru_{0.95}Fe_{0.05}/C and Ru_{0.95}Ni_{0.05}/C and Ru/C for the ORR in 0.1 M KOH solution. Although the reaction on Ru/C can reach the diffusion limited current of a 4-electron process, it is very sluggish, with a large overpotential. Small amounts (ca. 5 at. %) of Co or Ni alloying with Ru significantly enhanced the ORR kinetics in alkaline media. In contrast, small amounts (ca. 5 at. %) of Fe alloying with Ru inhibited the ORR kinetics in the first positive-going scan, while the ORR kinetics were enhanced in the subsequent positive-going scan, likely due to the dissolution of Fe from the surface of Ru_{0.95}Fe_{0.05}/C catalysts. Ru_{0.95}Co_{0.05}/C was found to be the most active among the three alloy catalysts tested. The half wave potential for the ORR on Ru_{0.95}Co_{0.05}/C was shifted positively by about 40 mV, when compared to Ru/C. At 0.85 V (vs. RHE), the MA and SA for Ru_{0.95}Co_{0.05}/C were about 4 times higher than for Ru/C (FIG. 9B). Further increases in the Co content in the Ru₁₋ₓCoₓ alloy catalysts resulted in a decrease of the ORR activity, likely due to a decrease in the surface Ru sites, as well as to the formation of more oxides (FIGS. 9C-D).

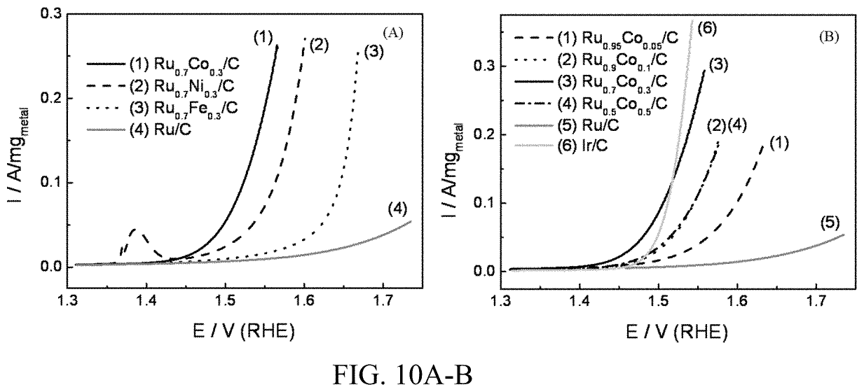

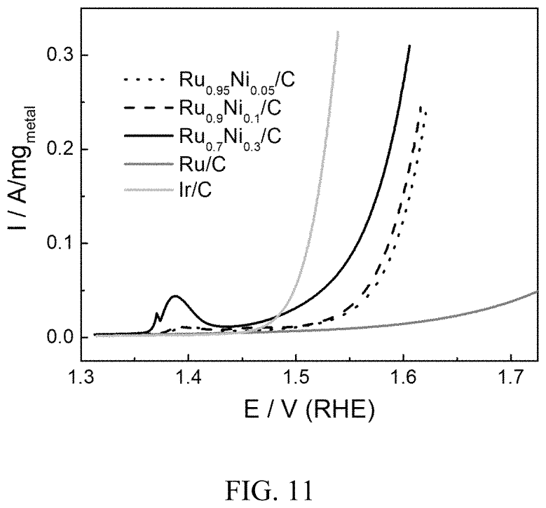

Oxygen Evolution Reaction. FIG. 10A presents the RDE voltammetric profiles of Ru_{0.7}Co_{0.3}/C, Ru_{0.7}Fe_{0.3}/C, Ru_{0.7}Ni_{0.3}/C and Ru/C for the OER in 0.1 M KOH solution. Unlike bulk Ru, the nanoparticle Ru catalyst exhibited a very low activity for the OER. However, alloying Ru with Co, Ni and Fe significantly enhanced the OER activity in alkaline media. Ru_{0.7}Co_{0.3}/C was the most active among all studied alloy catalysts. The effect of Co content in Ru₁₋ₓCoₓ/C on the OER activity is shown in FIG. 10B. The OER activity of Ru₁₋ₓCoₓ/C catalysts exhibited a volcano behavior with a maximum at a Co content of about 30%. In fact, Ru_{0.7}Co_{0.3}/C was even superior to an Ir/C catalyst at low overpotentials. Similarly, Ru_{0.7}Ni_{0.3}/C was found to be the most active among all studied Ru₁₋ₓNiₓ/C catalysts (FIG. 11).

Understanding the enhancement of the HOR, HER, ORR and OER activities of Ru₁₋ₓMₓ (x=Co, Ni, or Fe). Both the HOR and HER involve the formation of adsorbed H atoms as intermediates. According to the Sabatier principle, a plot of HOR or HER activity vs. H binding energy should exhibit a “volcano plot” shape.” Thus, the H binding energy can be used as a descriptor of electrocatalytic activity for the HOR and HER.

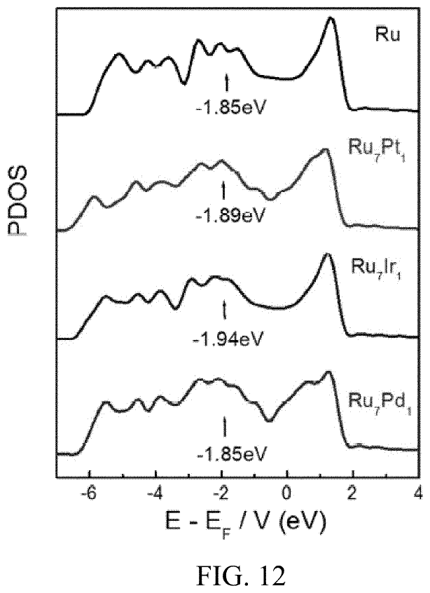

As established by data for embodiments of the inventive catalysts, alloying Ru with Co, Fe, Ni, Pt or Ir results in a down-shift of the Ru d-band center and, thus, a weakening of the H adsorption energy on Ru sites. This results in an enhancement of the reversibility of H adsorption/desorption processes in the cyclic voltammograms (FIGS. 2A-D). Therefore, both the HER and HOR activities are enhanced on these Ru alloy catalysts. In contrast, alloying Ru with Pd does not shift the Ru d-band center (FIG. 12), and thus rarely enhances the HOR and HER activity on Ru sites.

Embodiments of the inventive Ru₁₋ₓMₓ (M=Co, Ni or Fe) alloys have a hexagonal close packed (HCP) structure, in which each atom has a coordination number of 12. Ru₁₋ₓMₓ alloys with a M content of 5-10% exhibit the highest activity towards the HOR and HER. This suggests that in the most active Ru₁₋ₓMₓ catalysts, on average, each Ru atom has only one neighboring M atom, and meanwhile the amount of Ru surface sites is not significantly reduced, but the electronic structure of Ru could significantly be modified. Further increasing the Co, Ni or Fe content in Ru alloys results in a decrease of the catalytic activity likely due to the decrease in the amount of Ru surface sites.

Ensemble effects can also weaken H adsorption on Ru alloys, and thus could also contribute to the activity enhancement for the HOR and HER on Ru₁₋ₓMₓ alloys (M=Co, Ni, Fe, Pt and Ir). Adsorbed H on Ru prefers to occupy hcp and fcc sites, and the addition of a second element may reduce the ensembles of three adjacent Ru atoms. Since H adsorption on these second elements is much weaker than on Ru, and since surface Co, Ni and Fe sites can be covered by oxygen-containing species in the H region, some H atoms can only adsorb at the bridge sites of two-Ru-atom ensembles, and their adsorption would be anticipated to be much weaker than at the hcp and fcc sites. In contrast, Pd adsorbs H quite strongly (FIG. 11), so that the addition of Pd to Ru would form ensembles of Ru—Pd—Ru or Pd—Ru—Pd, on which H adsorption energy would be comparable to that on Ru—Ru—Ru ensembles, and thus one would anticipate small changes in the H adsorption energy. Both electronic effects and ensemble effects are very small for H adsorption on RuPd alloys, and thus the HOR and HER activities on RuPd alloys are minimally affected.

As established by data presented herein, Ru alloying with Co, Fe or Ni can also enhance ORR activity. The enhancement of the ORR on Ru alloy catalysts can also be attributed to electronic effects, i.e. a down-shift of the d band center of Ru, and/or the ensemble effect, which weakens O adsorption.

A synergistic effect for the OER on Ru₁₋ₓMₓ (M=Co, Ni or Fe) nanoparticle catalysts can also be attributed to a weakening of O binding by doping with Co, Ni or Fe. However, an oxide layer can be formed on the surfaces of Ru and Ru₁₋ₓMₓ (M=Co, Ni or Fe) nanoparticles at potentials relevant to the OER, and thus the surface properties may be quite different from the bulk.

In summary, a series of Ru₁₋ₓCoₓ/C, Ru₁₋ₓNiₓ/C and Ru₁₋ₓFeₓ/C alloy nanoparticle catalysts have been synthesized via an impregnation method and characterized by XRD, EDX, TEM, STEM and EELS elemental mapping. RDE voltammetry was performed to study the catalytic activity of these materials for the HOR, HER, ORR and OER. A synergistic effect for the HOR, HER, ORR and OER on RuCo/C, RuNi/C and RuFe/C alloy nanoparticle catalysts was observed due to electronic effects and/or the ensemble effect. All the studied Ru₁₋ₓCoₓ/C, Ru₁₋ₓNiₓ/C and Ru₁₋ₓFeₓ/C alloy nanoparticle catalysts were more active than pure Ru/C towards the HOR, HER, ORR and OER. Ru_{0.95}Co_{0.05}/C was the most active among all the studied carbon supported Ru alloy catalysts for the HOR, HER and ORR, while Ru_{0.7}Co_{0.3}/C exhibited the highest activity towards the OER. In particular, as for the HER and HOR, Ru_{0.95}Co_{0.05}/C was more active than Pt/C in terms of mass activity, and was comparable to or even more active than Ru_{0.9}Pt_{0.1}/C and Ru_{0.9}Ir_{0.1}/C. Moreover, Ru_{0.95}Co_{0.05}/C is much less expensive than Pt and Ir, and thus is a promising catalyst for the HOR and HER in alkaline media. DFT calculations indicate that the Ru d-band center of Ru alloys is down shifted, when compared to pure Ru, and thus H and O adsorption on Ru alloys becomes weaker.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1 A catalytically active particle comprising an alloy, said alloy comprising:
greater than or equal to 50 atomic % ruthenium (Ru); and
1 to 50 atomic % of one or more transition metals (M) selected from cobalt (Co), nickel (Ni), and iron (Fe),
wherein the sum of the atomic percentages of Ru and M is greater than 65 atomic % of the alloy, and wherein, in the particle, the alloy is not fully or partially encapsulated by a layer of platinum atoms.

2. The catalytically active particle according to claim 1, wherein the sum of the atomic percentages of Ru and M is greater than or equal to 85 atomic % of the alloy.

3. The catalytically active particle according to claim 1, consisting of:
greater than or equal to 50 atomic % Ru;
1 to 50 atomic % of one or more transition metals (M) selected from cobalt (Co), nickel (Ni), and iron (Fe); and
less than 5 atomic % of one or more additional elements.

4. The catalytically active particle according to claim 1, wherein at least 90 volume % of the alloy has a hexagonal close packed (hcp) crystal structure.

5. The catalytically active particle according to claim 1, wherein the alloy is a single phase alloy.

6. The catalytically active particle according to claim 1, wherein the alloy is of formula (I):
Ru₁₀₀₋ₓMₓ (I),
wherein x is the atomic % of one or more transition metals (M) present, wherein M is selected from Co, Ni, Fe, and a combination thereof, and 1≤x≤50.

7. The catalytically active particle according to claim 6, wherein M is Co, Ni, or Fe.

8. The catalytically active particle according to claim 6, wherein M is Co.

9. The catalytically active particle according to claim 6, wherein M is Fe.

10. The catalytically active particle according to claim 6, wherein M is Ni.

11. The catalytically active particle according to claim 10, comprising 1 to 30 atomic % Ni.

12. The catalytically active particle according to claim 6, wherein at least 99 wt. % of the catalytically active particle consists of Ru and M.

13. The catalytically active particle according to claim 1, wherein the particle has a size of 1 to 50 nm.

14. A device comprising the catalytically active particle according to claim 1.

15. The device according to claim 14, wherein the device is an electrolyzer comprising an anode and a cathode, wherein said catalytically active particle is in direct electrical contact with at least one of the anode or the cathode.

16. A fuel cell comprising the catalytically active particle according to claim 1.

17. The fuel cell according to claim 16, wherein the fuel cell is an anion-exchange membrane fuel cell (AEMFC).

18. The AEMFC according to claim 17, comprising:
an anode;
a cathode; and
an anion-exchange membrane (AEM) configured to transport hydroxide ions from the cathode to the anode,
wherein at least one of the anode or the cathode comprises a catalytically active particle comprising an alloy, said alloy comprising:
greater than or equal to 50 atomic % ruthenium (Ru); and
1 to 50 atomic % of one or more transition metals (M) selected from cobalt (Co), nickel (Ni), and iron (Fe),
wherein the sum of the atomic percentages of Ru and M is greater than 65 atomic % of the alloy, and wherein, in the particle, the alloy is not fully or partially encapsulated by a layer of platinum atoms.

19. An electrocatalytic process, wherein said process comprises use of the catalytically active particle according to claim 1.

20. The electrocatalytic process according to claim 19, wherein the process comprises a H₂ oxidation reaction (HOR), H₂ evolution reaction (HER), O₂ reduction reaction (ORR), or oxygen evolution reaction (OER).

21. The electrocatalytic process according to claim 20, wherein the process is performed at a pH>7.

22. The electrocatalytic process according to claim 21, wherein the process takes place in an anion-exchange membrane fuel cell (AEMFC).

23. The electrocatalytic process according to claim 19, wherein the process takes place in an anion-exchange membrane water electrolyzer (AEMWE).
